(19) United States
(12) Patent Application Publication
(10) Pub. No.: US 2003/0106850 A1
(43) Pub. Date: Jun. 12, 2003

(54) Filter, for the microfiltration in particular and equipment comprising such a filter

(76) Inventors: Marc Arnaut, Knesselare (BE); Joan Grabuleda, Barcelona (ES)

Correspondence Address: FOLEY AND LARDNER, SUITE 500, 3000 K STREET NW, WASHINGTON, DC, 20007, US

(21) Appl. No.: 10/220,508

(22) PCT Filed: Feb. 21, 2001
(86) PCT No.: PCT/EP01/01949

(30) Foreign Application Priority Data
Mar. 1, 2000 (ES) P20000499

(51) Int. Cl. B01D 25/00

(52) U.S. Cl. 210/323.1; 210/332; 210/407; 210/506; 210/500.1

(57) ABSTRACT

The invention relates to a filter in particular adapted for micro- and ultrafiltration applications. The filter comprises at least one filter element and a central axis. The filter element comprises at least one sintered and isostatically cold pressed non woven metal fiber web and means for sealing.

### FIELD OF THE INVENTION

The present invention relates to a filter and more particularly to a filter used for micro- and ultrafiltration applications. The filter according to the present invention is in particular suitable for the filtration of food and beverages.

The invention also relates to an equipment comprising such a filter.

### BACKGROUND OF THE INVENTION

Micro- and ultrafiltration is for example requested in the filtration of food and beverages.

For the filtration of wine for example, it is very important to use filters that do not permit the passage of not-wanted particles in order to eliminate these particles before the wine is set into bottles.

In micro- and ultrafiltration, there are mainly two different techniques used.

One can first mention surface filtration techniques using cartridges or disks, for example made of paper, non woven polymerics or woven meshes. Dirt holding capacities obtained by using these media are rather low since it concerns a surface filtration and not an in-depth filtration.

The media are clogged up after a short period of use and have to be cleaned or reconditioned before further use.

One also knows microfiltration techniques using filter aids such as diatomaceous earth. In the food and beverage industry, at present this is the most frequently applied method.

In this method, the filter medium is formed by the filter cake comprising the diatomaceous earth and the retained particles. This method allows it to obtain a relatively good filter efficiency but has also a number of drawbacks.

One drawback is that the diatomaceous earth, containing the retained particles, has to be removed at regular times. When the filter cake comprising the diatomaceous earth reaches a certain thickness, the filter is clogged up and as a consequence the filter is not longer usable unless high efforts are made to remove the filter cake. The residuals have to be disposed and the filter system has to be cleaned before the filter system can be restarted.

The use of diatomaceous earth has to be avoided since it is considered to be carcinogenic. Diatomaceous earth used for the filtration of food and beverages can be breathed by the workers for example during the manipulation and during the renewal of the diatomaceous earth.

The regularly renewal of the diatomaceous earth implies thus not only a high cost on the filtration process and a lower production efficiency but increases also the risk to cause carcinogenic diseases.

On the other hand, according to the patent application WO 99/03559, the use of a sintered and isostatically cold pressed non woven metal fiber web is known for the filtration of fruit beverages during their preparation.

### SUMMARY OF THE INVENTION

The object of the present invention is to provide a filter that does not present the above-mentioned drawbacks.

According to a first aspect of the invention a filter is provided. The filter according to the invention is in particular suitable for micro- and ultrafiltration applications. It is for example suitable for the filtration of fruit beverages and oils. The filter according to the present invention can also be used in many chemical processes, for example for the filtration of chemicals, such as low viscous fluids.

The term fruit beverages is intended to be considered as a generic term and comprises for example beer, wine and fruit juice.

The term oil is intended to comprise all different kinds of oils, for example vegetable oils such as olive oil.

Micro- and ultrafiltration refers to filters which are able to retain particles with a size below 5 μm, and in particular particles with a size below 1 μm, such as particles with a size of 0.5 μm or 0.1 μm.

The filter according to the invention comprises at least one filter element and a central axis. The central axis comprises a tube through which the filtered liquid is carried away. The filter element or elements is/are mounted on the central axis.

A filter element comprises at least one non woven metal fiber web. The metal fiber web is sintered and isostatically cold pressed.

A filter element further comprises means for sealing, assuring an adequate sealing at the joining of the various parts of the filter element.

The means for sealing comprise preferably sealing rings. The sealing rings are placed against the sintered and isostatically cold pressed non woven metal fiber web.

Possibly, there are also means for sealing between the filter element and the central axis.

An advantage of the filter according to the present invention is that the filter element does not require welds. When the filter membrane is sealed by means of welds, the sealing is not always sufficient to guarantee the required filter ratings and filter efficiency for micro- and ultrafiltration.

In a preferred embodiment a number of filter elements are disposed side by side on the central axis.

The non woven sintered metal fiber web comprises preferably metal fibers with a diameter ranging between 2 and 30 μm.

The fibers are preferably stainless steel fibers for example made of the alloy 316 L. Other suitable alloys are for example FeCrAlloy®, Alloy HR, Aluchrome®.

The non woven metal fiber web has preferably a weight between 300 and 1500 g/m². The porosity of the metal fiber web is preferably between 30 and 80%.

During the isostatically cold pressing, the web is exposed to an isostatical pressure higher than 2×10⁸ Pa and preferably to a pressure higher than 2.5×10⁸ Pa.

By the isostatically pressing operation a homogeneous porosity over the entire surface of the web is obtained.

The air permeability of the web is higher than 1I/dm²/min at a pressure of 200 Pa.

In addition to the metal fibers, the sintered metal fiber web may comprise metal particles, for examples metal powder particles and/or inorganic particles, such as metal oxide particles. Examples of metal oxide particles are TiO₂, ZrO₂, Al₂O₃, α-Al₂O₃ particles or mixtures thereof. Preferably, the metal oxide particles are sintered to the metal fiber web.

In one embodiment of the invention the non woven metal fiber web comprises a number of layers, the one placed on top of the other. Each of these layers comprises a non woven metal fiber web. Such a multi-layered structure comprises for example a first layer comprising metal fibers with a diameter of 6.5 μm, a second layer comprising metal fibers with a diameter of 4 μm and a third layer comprising metal fibers with a diameter of 2 μm.

The structure of the sintered and isostatically pressed non woven metal fiber web permits the filtration of particles of a size equal to or even lower than one micrometer, for example particles with a size of 0.5 or 0.1 μm.

Furthermore, an in-depth filtration is obtained. This means that the contaminants are captured within the structure of the non woven metal fiber web.

The metal fiber web can be sterilised for example in a chemical way or by steam sterilisation, for example at a temperature of 120° C. or higher.

A further advantage of the metal fiber web is that it can withstand high throughputs and high pressures.

The sintered and isostatically cold pressed non woven metal fiber web as such is functioning as filter membrane. The use of filter aids, such as diatomaceous earth is thus not necessary. This results in an improvement of the work conditions of the workers doing the maintenance of the equipments at the one hand and it permits to obtain a reduction of the operation costs at the other hand.

During the preparation of fruit beverages such as wine, small tartrate crystals such as potassium bitartrate crystals may be formed.

The sintered and isostatically cold pressed non woven metal fiber web forms a base for the carried-along tartrate crystals. These tartrate crystals form a non-deformable precoat layer on the metal fiber web. This layer is functioning as a micro- or ultramembrane filter layer and improves the filter efficiency of the sintered and isostatically cold pressed non woven metal fiber web.

Furthermore, it has been shown, that a non woven metal fiber web on which a precoat layer of tartrate crystals is formed clogs up much slower than a filter membrane without precoat layer.

Preferably, the central axis is placed in a horizontal or substantially horizontal position inside the pressurised vessel.

This orientation of the central axis allows it to place the filter elements vertically or substantially vertically. This facilitates the cleaning process of the filter elements.

In a preferred embodiment of the invention, each of the filter elements of the filter comprises a sintered, isostatically cold pressed non woven metal fiber web at each of the sides of the filter element.

According to a further embodiment, the filter elements may further comprise at least one support layer.

The support layer is preferably made of stainless steel.

In a preferred embodiment, each of the filter elements comprises a central perforated plate and at each side of the filter element a sintered and isostatically cold pressed non woven metal fiber web supported by at least two support layers.

In this embodiment, the support layers and the central perforated plate give the filter a high mechanical strength and rigidity.

The support layers may form a multi-layer with a gradual structure. Preferably, the support layer located most outside has a smaller filter rating and a lower strength and rigidity whereas the support layer located most interior has a bigger filter rating and a higher rigidity and strength. The support layers permit the drainage of the liquid on the other hand.

Filter elements comprising sintered and isostatically non woven metal fiber webs at each of their sides permit the filtration of a bigger quantity of liquid per unit of filter surface and per unit of time compared with filters using diatomaceous earth. The latter can only be used at one side of the filter element.

In a further embodiment of the present invention, the filter is characterised by the fact that the means for sealing between the sintered metal fiber web and the filter element, comprise at least one sealing ring with a torus-like shape in the exterior zone of the metal fiber web and a flat sealing ring in the interior zone of the metal fiber web.

The exterior zone of the metal fiber web is the zone located at the outer circumference of the metal fiber web; whereas the interior zone of the metal fiber web is the zone located close to the central axis.

The setting up of these means for sealing is an important factor in the process of filtration, because it results in an adequate sealing in the various zones of contact between the metal fiber web and the other parts of the filter element, such as the inner and the outer ring.

If these means for sealing would not be present, particles with a size superior to one micrometer could pass through the zone where the different pieces of the filter element are joined.

Advantageously, the torus-shaped sealing ring is placed against the sintered and isostatically cold pressed non woven metal fiber web. The metal fiber web is held between the surfaces of two annular pieces. The annular pieces are part of the outer ring and are fixed to each other by removable means of fixing such as screws.

Because of this disposition of the torus-shaped sealing ring, one obtains a good sealing between the non woven metal fiber web and the other parts of the filter element, more particularly the outer ring of the filter element, by fastening the removable means of fixing.

According to another embodiment of the invention, a flat sealing ring is disposed against the sintered and isostatically cold pressed non woven metal fiber web. The metal fiber web is held between the surfaces of two annular pieces. The annular pieces are part of the outer ring and are fixed to each other by removable means of fixing such as screws.

In this way, one obtains a good sealing by fastening the removable means of fixing.

According to another aspect of the invention, the filter further comprises means for sealing between the filter element and the central axis. These means for sealing comprise for example two torus-shaped sealing rings, situated at the two sides of the interior zone of a filter element.

According to an embodiment of the invention, the filter comprises means for cleaning.

In one embodiment the inside of the reservoir comprises a number of sprayers. The sprayers are preferably located between the filter elements. The dirt particles from the filter element and from the non woven metal fiber web are removed by the liquid or air and by the effect of the gravity.

The means for cleaning may also comprise means using ultrasonic waves.

These means can be used in stead of the sprayers or they can be use in addition to the sprayers.

According to an embodiment of the invention, the means for cleaning are automated. Thanks to this system, the opening of the reservoir during the cleaning is not necessary. This is making the maintenance of the filter and the filter equipment more easy compared to the one of the conventional used filtration equipments.

According to another aspect of the invention an equipment, in particular suitable for micro- and ultrafiltration applications, is provided. The equipment comprises a filter as described above.

Preferably, the equipment comprises means for controlling the automatisation of the filtration process.

### BRIEF DESCRIPTION OF THE DRAWINGS

The invention will now be described into more detail with reference to the accompanying drawings wherein

FIG. 1 is a cross-section of the inside of a pressurised reservoir according to a preferred embodiment of the present invention;

FIG. 2 shows a partial cross-section of a filter element;

FIG. 3 shows a detail of FIG. 2, corresponding with the exterior part the filter element;

FIG. 4 shows a detail of FIG. 2, corresponding with the interior part of the filter element;

FIG. 5 is a view in perspective of the exterior part of a filter element;

FIG. 6 is a view in perspective of the interior part of a filter element; and

FIG. 7 is a frontal view of a filter element.

### DESCRIPTION OF THE PREFERRED EMBODIMENTS OF THE INVENTION

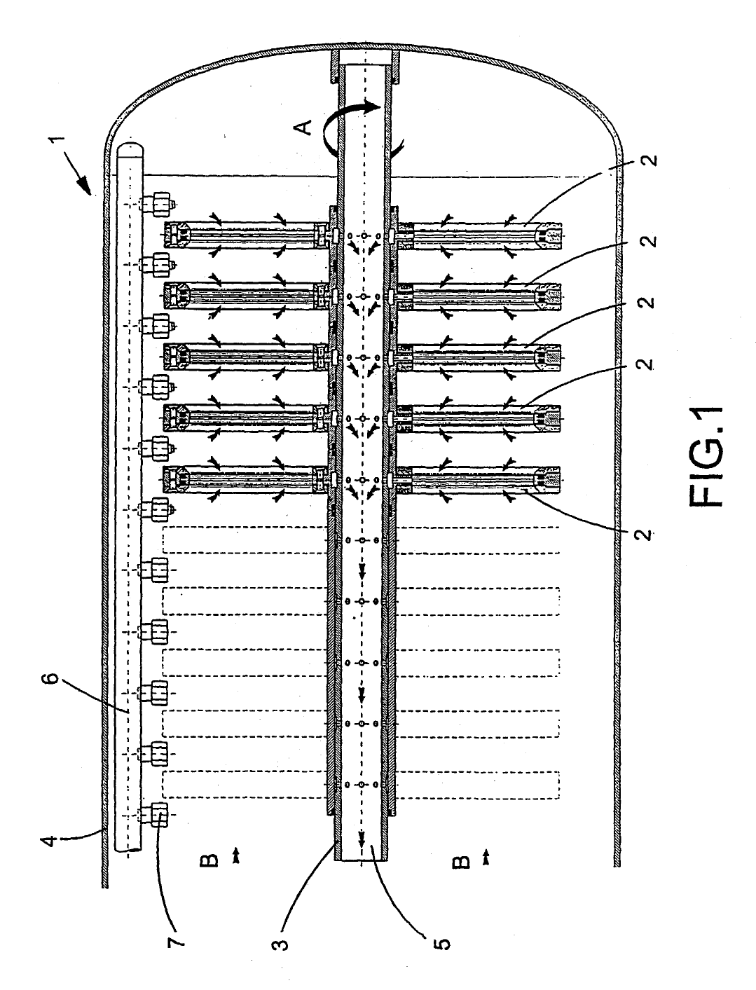

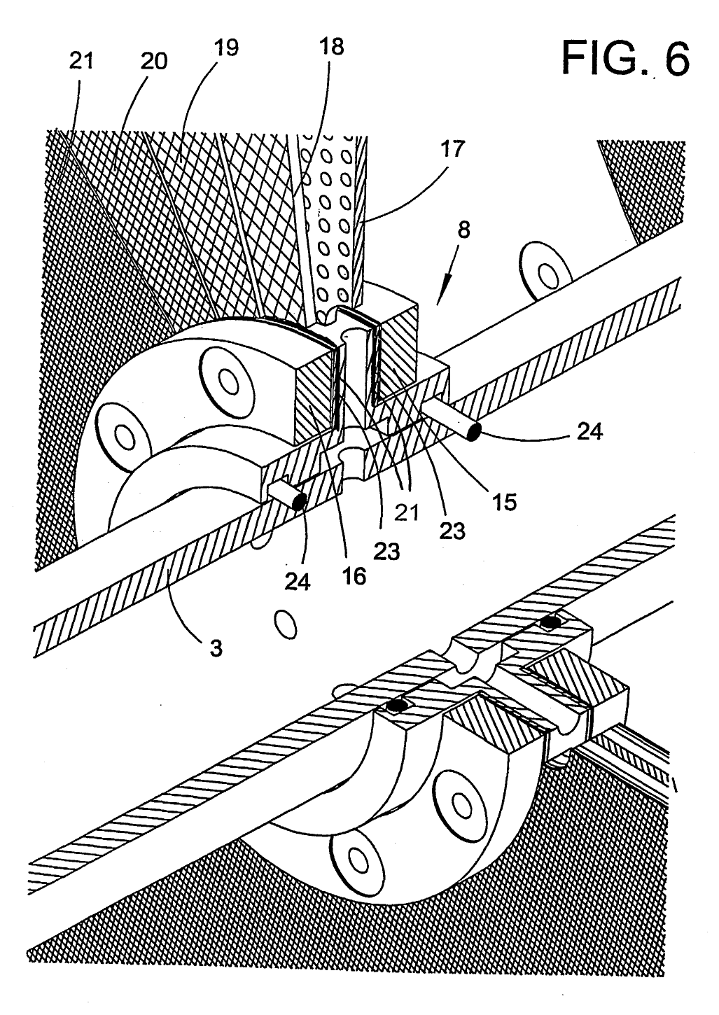

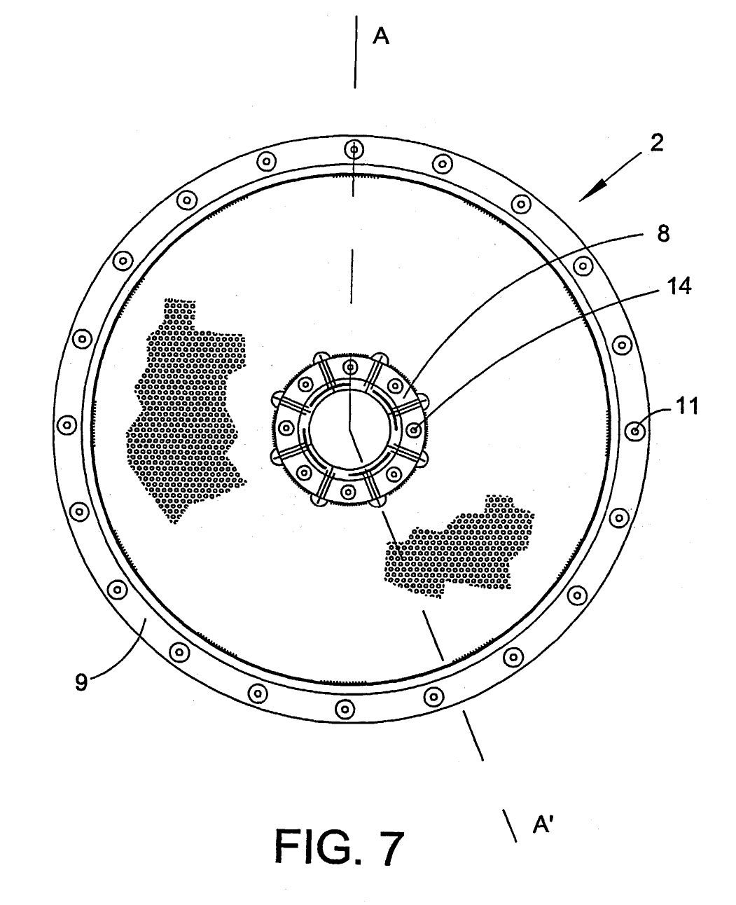

As one can see on FIG. 1, the filter 1 according to the present invention used for microfiltration comprises filter elements 2. The filter elements have a disk-like shape and are mounted on a central axis 3 inside a pressurised reservoir 4. The central axis has preferably a horizontal or substantially horizontal position. A tube to carry the filtered liquid away is disposed at the interior of the central axis 3 (see FIGS. 1 and 6).

In the superior part of the pressurised reservoir 4 a tubing system 6 is provided. The tubing system is connected to a number of sprayers 7.

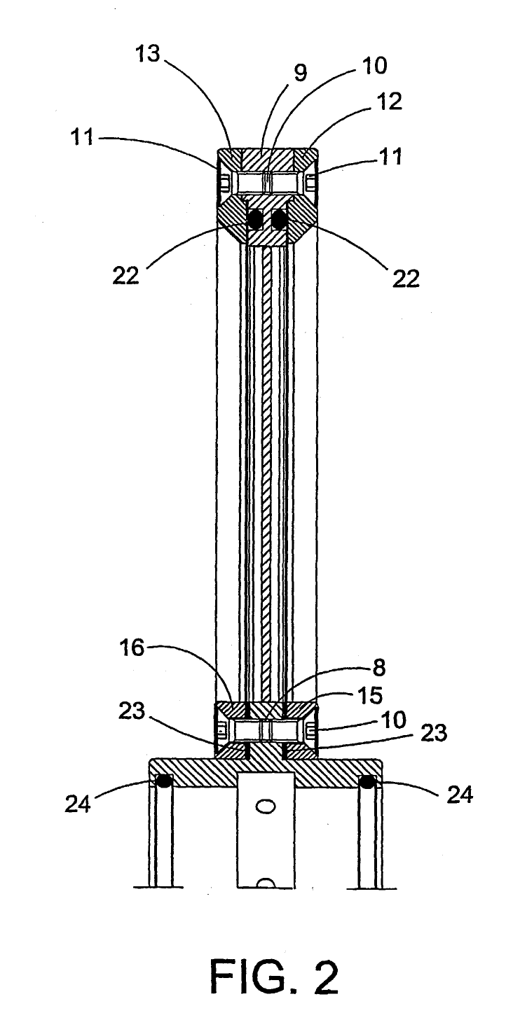

On FIG. 2, one can see that each of the filter elements 2 comprises an inner ring 8 and an outer ring 9.

The inner ring has a central opening wherein the axis 3 is placed.

The outer ring 9 comprises a number of openings 10, disposed axially, intended to place screws 11 in order to join the two annular pieces 12, 13 of the outer ring 9 together.

In a similar way, screws 14 serve to join the annular pieces 15, 16 of the inner ring 8.

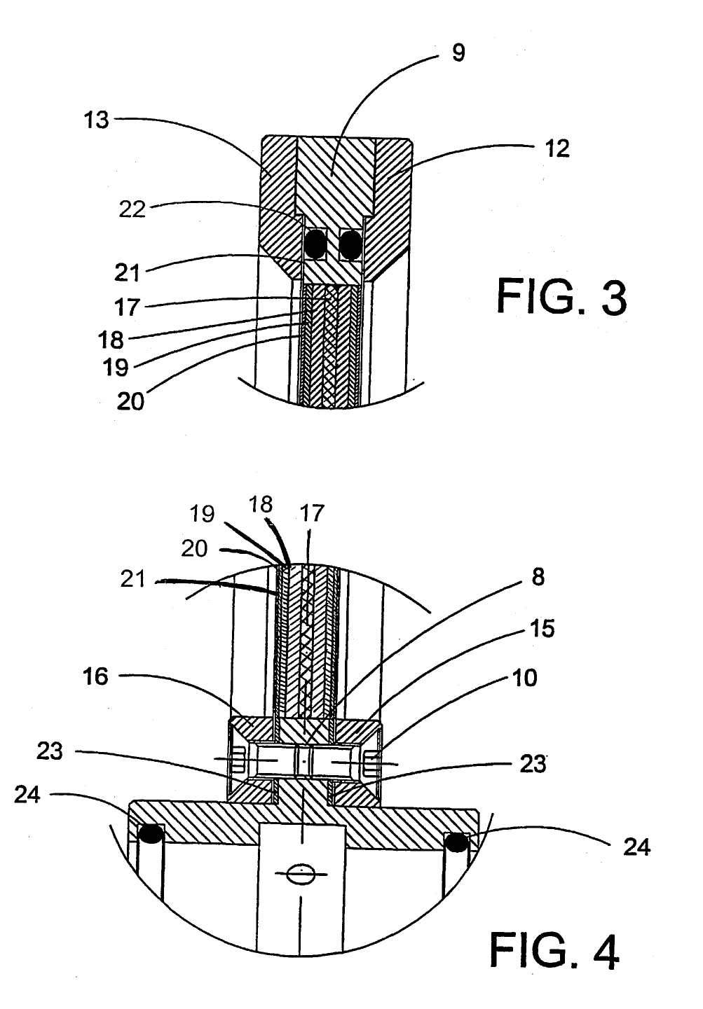

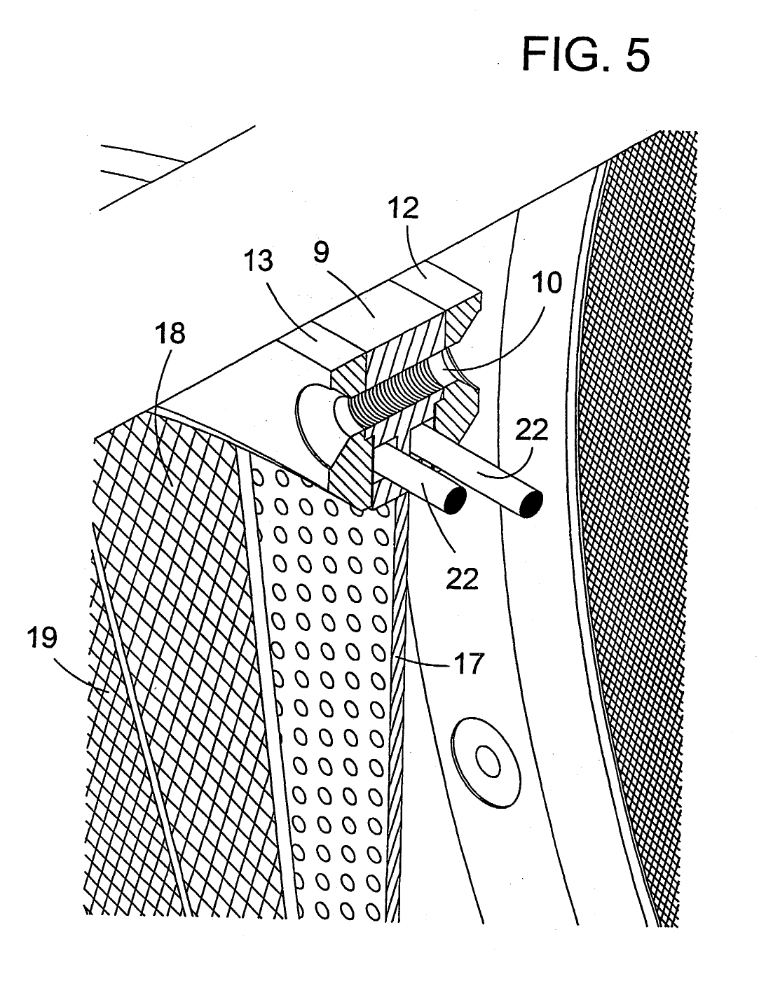

Between the two rings 8 and 9 (see FIGS. 3 to 6) one can observe a perforated plate 17, a number of support layers 18, 19, 20 and a sintered and isostatically cold pressed non woven metal fiber web 21. The non woven metal fiber web 21 functions as filter membrane.

The support layer may also comprise non woven metal fiber webs.

In the embodiment shown in FIGS. 3 to 6, the sintered and isostatically cold pressed non woven metal fiber webs 21 comprise three layers of metal fiber webs.

As one can notice on the FIGS. 2, 3 and 5, the outer ring 9, comprises two sealing rings 22 with a torus-like shape providing the desired sealing between the outer ring 9 and the metal fiber web 21 acting as filter membrane.

As one can see, the web 21 is held between the outer ring 9 and the annular pieces 12, 13.

As FIGS. 2, 4, and 6 show the inner ring 8 comprises two flat sealing rings 23, arranged against the metal fiber web 21 acting as filter membrane.

The metal fiber web 21 is held between the surface of the two annular pieces 15 and 16 by means of screws 14.

On the same FIGS. 2, 4 and 6 one can see two sealing rings with a torus-like shape 24, in the zone where the filter element contacts the central axis 3.

Starting from the drawings and the description one can derive the working of the filter of the present invention easily.

As is indicated by the arrow A of FIG. 1, the axis 3 on which the filter elements are mounted turns inside the pressurised reservoir 4.

The liquid to be filtered enters in the reservoir at the zones indicated by the arrows B. The small arrows indicate the direction of the circulation of the liquid from the two sides of each filter element 2 towards the tube 5, by which the filtered liquid is carried away.

Filtration, and in particular the cleaning of the filterable elements, is achieved in an automatic manner.

When the saturation of the filter elements is detected, the entry of the liquid is interrupted in an automatic way and the reservoir empties itself. Then the sprayers 7 are switched on. They remove the particles accumulated on the filter elements 2, the particles fall on the bottom of the reservoir 7, from where they are immediately eliminated.

1. A filter, for microfiltration applications in particular, comprising at least one filter element, a central axis, said central axis comprises a tube through which the filtered liquid is carried away, characterised in that said filter element is mounted on said central axis, said filter elements comprise at least one sintered and isostatically cold pressed non woven metal fiber web and means for sealing.

2. A filter according to claim 1, whereby said means for sealing are sealing rings placed against the sintered and isostatically cold pressed non woven metal fiber web.

3. A filter according to claim 1 or 2, whereby said filter further comprises means for sealing placed between the filter element and the central axis.

4. A filter according to any one of the preceding claims, whereby said sintered and isostatically cold pressed non woven metal fiber web is coated with an organic or inorganic coating layer.

5. A filter according to claim 4, whereby said inorganic coating comprises Al₂O₃, TiO₂ and/or ZrO₂-particles, said particles being sintered to said sintered and isostatically cold pressed non woven metal fiber web.

6. A filter according to any one of the preceding claims, whereby said sintered and isostatically cold pressed non woven metal fiber web forms a base for the carried-along crystals.

7. A filter according to any one of the preceding claims, whereby a number of filter elements are mounted on said central axis.

8. A filter according to any one of the preceding claims, whereby said sintered and isostatically cold pressed non woven metal fiber web comprises metal fibers having a diameter between 2 and 30 μm.

9. A filter according to any one of the preceding claims, whereby said sintered and isostatically cold pressed non woven metal fiber web has a filter rating lower than 1 μm.

10. A filter according to any one of the preceding claims, whereby said central axis is placed in a substantially horizontal position.

11. A filter according to any one of the preceding claims, whereby each of said filter elements comprises a sintered and isostatically cold pressed non woven metal fiber web at each of its sides.

12. A filter according to any one of the preceding claims, whereby each of said filter elements comprises at least one support layer.

13. A filter according to any one of the preceding claims, whereby each of said filter elements comprises a central perforated plate and at each side of the filter element at least two support layers with a gradual structure.

14. A filter according to any one of the preceding claims, whereby said means for sealing comprise at least one torus-shaped sealing ring in the exterior zone of said metal fiber web and at least one flat sealing ring in the interior zone of the metal fiber web.

15. A filter according to claim 14, whereby said torus-shaped sealing ring is disposed against the metal fiber web; said metal fiber web being held between the surfaces of two annular pieces; said annular pieces being part of an outer ring surrounding the metal fiber web and said annular pieces being fixed to each other by removable means of fixing.

16. A filter according to claim 14, whereby said flat sealing ring is disposed against the metal fiber web, said metal fiber web being held between the surfaces of two annular pieces, said annular pieces being part of an inner ring and said annular pieces being fixed to each other by removable means of fixing.

17. A filter according to any one of the preceding claims, whereby said means for sealing between the filter element and the central axis comprise at least two torus-shaped sealing rings.

18. A filter according to any one of the preceding claims, whereby said filter comprises means for cleaning.

19. A filter according to claim 18, whereby said means for cleaning comprise a number of sprayers, said sprayers being disposed between two consecutive filter elements.

20. A filter according to claim 18, whereby said means for cleaning are using ultrasonic waves.

21. A filter according to any one of claims 18 to 20, whereby said means for cleaning are automated.

22. An equipment, for microfiltration applications in particular, comprising a filter according to any one of claims 1 to 21, characterised in that said equipment comprises controlling means for the automatisation of the filtration process.
